(19) United States
(12) Patent Application Publication
(10) Pub. No.: US 2002/0189077 A1
(43) Pub. Date: Dec. 19, 2002

(54) Magnetic head registration method, pallet device, and registration jig

(76) Inventors: Masao Habe, Chiba-shi (JP); Motoji Amakura, Chiba-shi (JP)

Correspondence Address: ADAMS & WILKS, ATTORNEYS AND COUNSELORS AT LAW, 31st FLOOR, 50 BROADWAY, NEW YORK, NY, 10004, US

(21) Appl. No.: 10/153,538

(22) Filed: May 22, 2002

(30) Foreign Application Priority Data
Jun. 18, 2001 (JP) 2001-183210

(51) Int. Cl. G11B 5/127; H04R 31/00; B23P 19/00

(52) U.S. Cl. 29/603.06; 29/603.04; 29/760; 29/729

(57) ABSTRACT

Disclosed area high accuracy magnetic head registration method, pallet device, and registration jig which make it possible to realize automation of assembly operations and achieve an improvement in operational efficiency and yield. In the registration method, the magnetic heads are placed between the registration member and carriage arms such that the insertion holes of the magnetic heads are substantially opposed to caulking holes of the carriage arms, and in a state that the magnetic heads are placed between the carriage arms and the registration member, the magnetic heads are biased toward the carriage arm side by the registration member to thereby perform registration on the insertion holes of the magnetic heads with respect to the caulking holes of the carriage arms. By using the pallet device corresponding to the above steps, registration accuracy and operational efficiency are improved.

### BACKGROUND OF THE INVENTION

1. Field of the Invention

The present invention relates to a magnetic head registration method, a pallet device, and a registration jig for effecting registration of magnetic heads for performing at least one of writing and reading of information to and from a hard disk incorporated in a computer, VCR, or the like, to a position where the magnetic heads can be fixed by caulking to a carriage of a hard disk drive.

2. Description of the Related Art

Conventionally, when mounting magnetic heads of this type to a carriage, an assembly operator inserts annular protrusions of the magnetic heads into caulking holes of carriage arms and passes a steel ball through the annular protrusions and the caulking holes, thereby fixing the magnetic heads by caulking to the carriage arms.

The above technique of the prior art has the following problem: the magnetic head is assembled by a semi-automatic or a completely manual operation in which the operator assembles the magnetic heads using equipment, so that, to prevent breakage of the magnetic heads due to static electricity and to achieve an improvement in operational accuracy, the operator is required to have a predetermined level of skill. Thus, there has been a demand for a technique which allows mass production.

### SUMMARY OF THE INVENTION

The present invention has been made in view of the above problem. It is an object of the present invention therefore to provide a high accuracy magnetic head registration method, a pallet device, and a registration jig which help to realize automation of assembly operations and achieve an improvement in terms of operational efficiency and yield.

To achieve the above object, there is provided, in accordance with the present invention, a magnetic head registration method comprising:

setting a registration member such that magnetic heads can be placed between the registration member and carriage arms;

placing the magnetic heads between the carriage arms and the registration member such that insertion holes of the magnetic heads are substantially opposed to caulking holes of the carriage arms;

arranging the centers of the caulking holes of the carriage arms and the insertion holes of the magnetic heads substantially coaxially;

biasing the magnetic heads toward the carriage arm side by the registration member to thereby fit annular protrusions formed in the periphery of the insertion holes of the magnetic heads into the caulking holes of the carriage arms; and

biasing the magnetic heads with further force by the registration member while maintaining the fit-in state to thereby bring the insertion holes of the magnetic heads into close contact with the caulking holes of the carriage arms to attain a state in which caulking fixation is possible.

In the magnetic head registration method in accordance with the present invention, registration is performed on the insertion holes of the magnetic heads with respect to the caulking holes of the carriage arms of the carriage, whereby it is possible to attain a state in which the magnetic heads can be fixed by caulking to the carriage arms. Further, the magnetic heads are placed between the registration member and the carriage arms such that the insertion holes of the magnetic heads are substantially opposed to the caulking holes of the carriage arms, and in the state in which the magnetic heads are so placed between the carriage arms and the registration member, the centers of the caulking holes of the carriage arms and the insertion holes of the magnetic heads are arranged substantially coaxially, so that it is possible to prevent the magnetic heads from being greatly deviated in position, making it possible to enhance the accuracy in registration and operational efficiency. Next, the magnetic heads are biased toward the carriage arm sides by the registration member, whereby the annular protrusions formed in the periphery of the insertion holes of the magnetic heads are fitted into the caulking holes of the carriage arms. Then, while maintaining the fit-in state, the magnetic heads are biased with further force by the registration member, whereby the insertion holes of the magnetic heads and the caulking holes of the carriage arms are brought into close contact with each other, thereby achieving a state in which caulking fixation is possible.

In accordance with the present invention, there is provided a pallet device which is conveyed in each step while holding a carriage when mounting the magnetic heads to the carriage, comprising a registration member for registration insertion holes of the magnetic heads with respect to caulking holes of a plurality of carriage arms provided in the carriage,

wherein the registration member is equipped with:

a first portion for attaining a first state in which the magnetic heads can be respectively placed between the carriage arms in a condition in which the registration member is positioned between the carriage arms;

a second portion which has a diameter larger than that of the first portion and which, after the state has been attained in which the magnetic heads are respectively placed between the first portion and the carriage arms, is pushed in between the carriage arms to bias the magnetic heads toward the carriage arm side to thereby achieve a second state in which the annular protrusions formed in the periphery of the insertion holes of the respective magnetic heads are fitted into the caulking holes of the carriage arms;

a third portion which has a diameter larger than that of the second portion and which, after the state has been achieved in which the annular protrusions of the respective magnetic heads are fitted into the caulking holes of the carriage arms, is pushed in between the carriage arms to bias the magnetic heads with further force toward the carriage arm side to thereby bring the insertion holes of the magnetic heads into close contact with the caulking holes of the carriage arms to realize a third state in which caulking fixation is possible; and

a fourth portion which exists between the second portion and the third portion and which serves to maintain the state in which the magnetic heads are biased toward the carriage arm side also during transition from the second state to the third state.

It is possible for the pallet device to have such a construction that it further comprises a guide member for guiding the registration member such that it can operate in a predetermined direction during transition from the first state through the third state,

wherein, in the third state, a predetermined clearance is provided between the registration member and the guide member so that the registration member can make small movements in the biasing direction.

The pallet device of the present invention is equipped with a registration jig on which a carriage is mounted and which performs registration on magnetic heads, so that, by performing registration the insertion holes of the magnetic heads to the caulking holes of the carriage arms of the carriage, it is possible to attain a state in which the magnetic heads can be fixed by caulking to the carriage arms. That is, in a state in which they exist between the carriage arms by virtue of the first portion, the magnetic heads can be placed between the first portion and the carriage arms on either side. The second portion has a diameter larger than that of the first portion, and after the state has been attained in which the magnetic heads are placed between the first portion and the carriage arms on either side, it is pushed in between the carriage arms to bias the magnetic heads toward the carriage arm side to thereby realize a second state in which annular protrusions formed in the periphery of the insertion holes of the magnetic heads are fitted into the caulking holes of the carriage arms. The third portion has a diameter larger than that of the second portion, and after the state has been attained in which the annular protrusions of the magnetic heads are fitted into the caulking holes of the carriage arms, it is pushed in between the carriage arms to bias the magnetic heads with further force toward the carriage arm side to thereby bring the insertion hole of the magnetic heads into close contact with the caulking holes of the carriage arms, realizing a third state in which caulking fixation is possible. Further, the fourth portion exists between the second and third portions and can maintain the state in which the magnetic heads are biased against the carriage arms also during the transition from the second state to the third state.

Further, the pallet device can be provided with the guide member which guides the registration member such that it can operate in a predetermined direction during the transition from the first state to the third state, whereby it is possible to smoothly guide the operation of the registration member. Further, in the third state, a predetermined clearance is provided between the registration member and the guide member so that the registration member can make small movements in the biasing direction. Thus, the registration member can make small movements in the biasing direction, and when, after placing the magnetic heads, the caulking holes of the carriage arms and the annular protrusions of the magnetic heads are deviated from each other, the registration member makes small movements to adjust the position of the magnetic heads.

In the first and second states, it is desirable that no operation in the biasing direction be possible.

In accordance with the present invention, there is provided a registration jig which performs registration on insertion holes of magnetic heads with respect to caulking holes of carriage arms of a carriage to thereby attain a state in which the magnetic heads can be fixed by caulking to the carriage arms, the registration jig comprising a registration member and a guide member for guiding the registration member,

wherein the registration member is equipped with:

a first portion for attaining a first state in which the magnetic heads can be respectively placed between the carriage arms in a condition in which it is positioned between the carriage arms;

a second portion which has a diameter larger than that of the first portion and which, after the state has been attained in which the magnetic heads are respectively placed between the first portion and the carriage arms, is pushed in between the carriage arms to bias the magnetic heads toward the carriage arm side to thereby achieve a second state in which annular protrusions formed in the periphery of the insertion holes of the respective magnetic heads are fitted into the caulking holes of the carriage arms;

a third portion which has a diameter larger than that of the second portion and which, after the state has been achieved in which the annular protrusions of the respective magnetic heads are fitted into the caulking holes of the carriage arms, is pushed in between the carriage arms to bias the magnetic heads with further force toward the carriage arm side to thereby bring the insertion holes of the magnetic heads into close contact with the caulking holes of the carriage arms to realize a third state in which caulking fixation is possible; and

a fourth portion which exists between the second portion and the third portion and which serves to maintain the state in which the magnetic heads are biased toward the carriage arm side also during transition from the second state to the third state, and

wherein the guide member guides the registration member such that it can operate in a predetermined direction during transition from the first state to the third state.

In the registration jig of the present invention, registration is performed on insertion holes of magnetic heads with respect to caulking holes of carriage arms of a carriage, whereby it is possible to attain a state in which the magnetic heads can be fixed by caulking to the carriage arms. Further, registration can be effected on the magnetic heads while maintaining the state in which the registration jig is passed between the adjacent magnetic heads, so that it is possible to achieve an improvement in accuracy in the registration operation. Further, in the third state, a predetermined clearance is provided between the registration member and the guide member, so that the registration member can make small movements toward the biasing direction; when, after the magnetic heads have been placed, the caulking holes of the carriage arms and the annular protrusions of the magnetic heads are deviated from each other, the registration member makes small movements, making it possible to adjust the position of the magnetic heads.

Thus, by using a pallet device equipped with the above registration jig, the magnetic heads can be inserted between the carriage arms, and the magnetic head assembling operation can be automated.

### BRIEF DESCRIPTION OF THE DRAWINGS

In the accompanying drawings:

FIG. 1 is an elevation view showing an example of a pallet device according to the present invention;

FIG. 2 is a perspective view showing a carriage and a magnetic head used in an embodiment;

FIG. 3 is a diagram for illustrating the magnetic head registration method of an embodiment, showing the relationship between magnetic heads and a comb when inserting the magnetic heads between the carriage arms;

FIG. 4A is a diagram for illustrating the operation of a registration jig according to an embodiment, and a side view of the pallet device 400 of FIG. 1 as seen from the direction of the arrow B;

FIG. 4B is a diagram for illustrating the operation of a registration jig according to an embodiment, and a front view of the pallet device 400 of FIG. 1;

FIG. 5A is a diagram for illustrating the operation of a registration jig according to an embodiment, and a side view of the pallet device 400 of FIG. 1 as seen from the direction of the arrow B;

FIG. 5B is a diagram for illustrating the operation of a registration jig according to an embodiment, and a front view of the pallet device 400 of FIG. 1;

FIG. 6A is a diagram for illustrating the operation of a registration jig according to an embodiment, and a side view of the pallet device 400 of FIG. 1 as seen from the direction of the arrow B;

FIG. 6B is a diagram for illustrating the operation of a registration jig according to an embodiment, and a front view of the pallet device 400 of FIG. 1; and

FIGS. 7A and 7B are diagrams showing the relationship between the magnetic heads and the comb when inserting the magnetic heads between the carriage arms in an embodiment.

### DESCRIPTION OF THE PREFERRED EMBODIMENTS

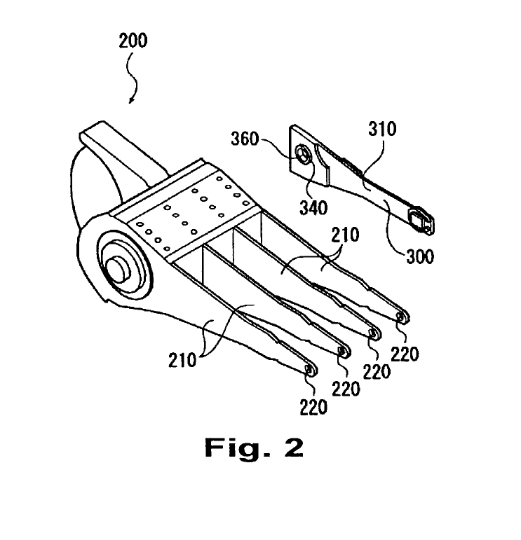

A magnetic head registration method and a pallet device of the present invention will now be described with reference to the drawings. First, a carriage and a magnetic head will be described. In FIG. 2, numeral 200 indicates a carriage, and numeral 300 indicates a magnetic head. The carriage 200 is equipped with a plurality of carriage arms 210 arranged at predetermined intervals. Each carriage arm has at its forward end a caulking hole 220 to which a magnetic head 300 is caulked.

The magnetic head 300 has at the rear end of a gimbal 310 an insertion hole 360, and an annular protrusion 340 for caulking is provided in the periphery of the insertion hole 360 so as to protrude from the back surface of the gimbal 310.

Registration is effected on the magnetic head 300 in accordance with the magnetic head registration method of the present invention, and then a steel ball is passed through the caulking hole 220, whereby the magnetic head 300 is fixed by caulking to the carriage 200.

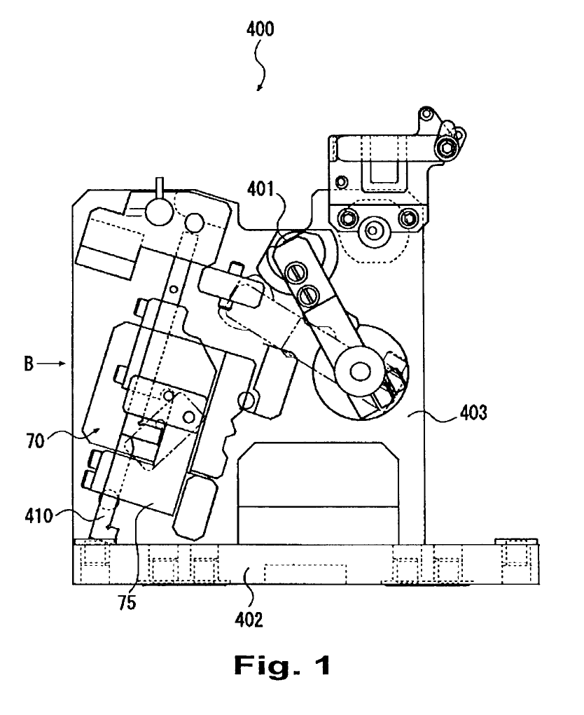

FIG. 1 is a front view showing an example of the pallet device according to the present invention. A pallet device 400 conveys the carriage 200 in each step by a conveyor provided in an assembly device (not shown) for assembling the magnetic heads 300 to the carriage 200, and its main portion is formed by a base portion 402 and a frame 403. The base portion 402 is placed on the conveyor for conveyance, and its size and other configurations are set so as to be in correspondence with the conveyor width and capable of being conveyed in a stable manner. The plate-like frame 403 formed on the base portion 402 is equipped with a placing portion 401 on which the carriage 200 is placed, and conveys by means of the conveyor the carriage 200 in each step for assembling the magnetic heads 300 onto the carriage 200.

As shown in FIG. 1, a registration jig 70 in an inclined position is provided on the side surface of the frame 403 of the pallet device 400. The registration jig 70 serves as a guide when inserting the magnetic heads 300 between the carriage arms 210, and its main portion is formed by a guide member 75 and a comb (registration member) 410. The comb (registration member) 410 is an elongated column-like member, and is attached to the inner side of the guide member 75 so as to be supported by the guide member 75. The pallet device 400 is appropriately equipped with various jigs corresponding to each step for the assembly device.

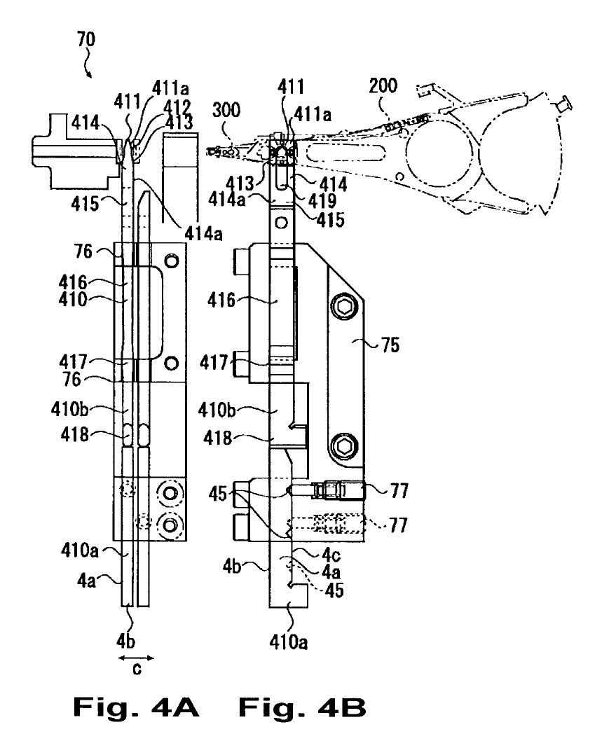

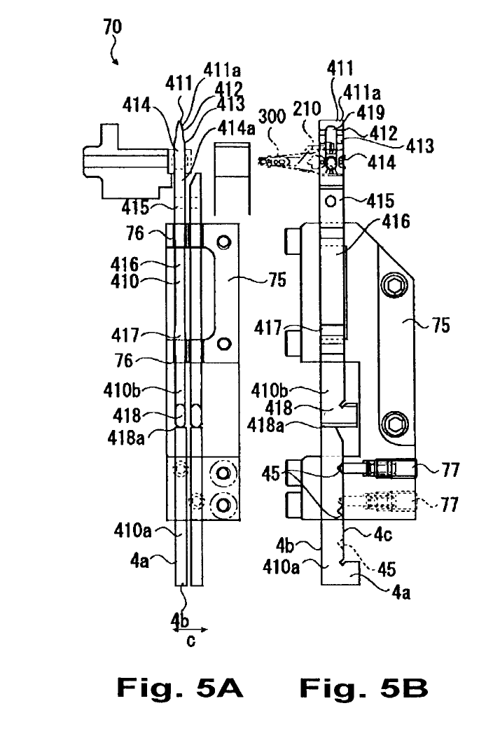

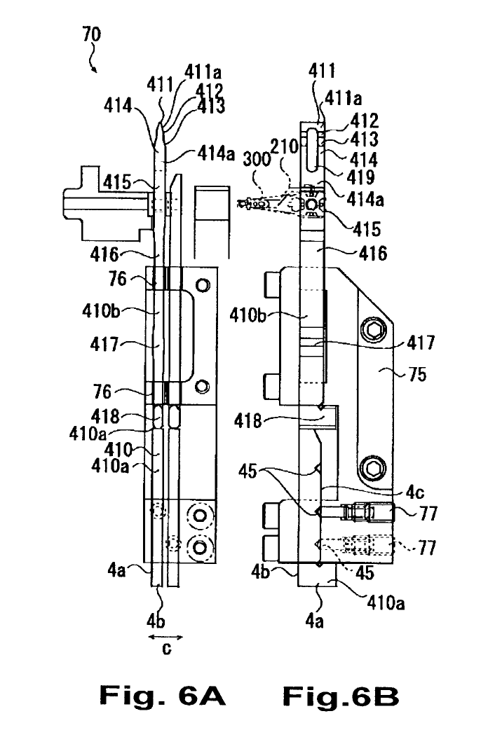

FIGS. 4 through 6 show the registration jig 70. As shown in FIG. 1 and FIGS. 4 through 6, the comb (registration member) 410 is formed by vertically connecting a first member 410a, which is an elongated column-like member with a substantially rectangular section, and a second member 410b.

In the second member 410b constituting the upper portion of the comb (registration member) 410, first and second side surfaces indicated by numerals 4b and 4c in FIGS. 4 through 6 have substantially flat surfaces, and a front portion 4a is slightly protruded and recessed, differing in thickness in the fore-and-aft direction indicated by the arrow C in portion (b).

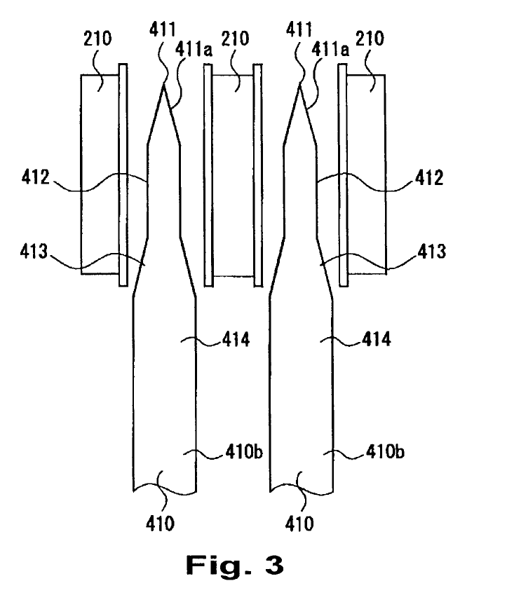

That is, as shown in FIGS. 3 through 6, the forward end portion 411 of the second member 410b is tapered, with its forward end being thin. Below an inclined portion 411a of the forward end portion 411, there is formed a first portion 412 whose thickness is set to be smaller than that of the lower portion of the second member 410b. Below the first portion 412, there is formed a second inclined portion 413 whose diameter gradually increases in a downward direction. Further, below the second inclined portion 413, there is formed a second portion 414 whose width is somewhat smaller than the space between the carriage arms 210.

Further, below the second portion 414, there is formed a third portion 415 having a large diameter so as to exhibit a larger thickness than that of the second portion 414. The portion between the second portion 414 and the third portion 415 is formed as a fourth portion 414b whose thickness is maintained to be at least the same as that of the second portion 414. Further, below the third portion 415, there is formed a thin-walled portion 416 which is slightly thinner than the third portion 415. Below the thin-walled portion 416, there is formed a swollen adjustment portion 417 whose width is substantially equal to the width of a guide groove 76 of the guide member 75. Below the adjustment portion 417, there is formed a lower end portion 418, and an inclined portion 418a inclined in the axial direction of the second member 410b.

The first member 410a, which supports the second member 410b, abuts the lower surface of the second member 410b. The first member 410a is formed in a column-like configuration with a substantially rectangular section, its lower end portion being bent at right angles to the second side surface 4c side like the second member 410b. On the second side surface 4c side of the first member 410a, there are formed three groove portions 45, into which a movable protrusion 77 provided on the guide member 75 is fitted, whereby the comb (registration member) 410 can be vertically stopped in three stages.

The second member 410b is supported in the vertical direction by the first member 410a and, in the horizontal direction, by the guide grooves 76 of the guide member 75.

The guide grooves 76 are provided at three vertical positions, and the width of the guide grooves 76 is set to be substantially equal to the width of the adjustment portion 417 of the first member 410a. By making the width of the guide grooves 76 substantially equal to the width of the adjustment portion 417, the comb (registration member) 410 can be supported so as not to move in the horizontal direction even if a force is applied to the comb (registration member) 410 from the front side 4a.

The width of the guide grooves 76 is slightly larger than that of the thin-walled portion 416, and a clearance is formed between the comb (registration member) 410 and the guide grooves 76; when the thin-walled portion 416 is positioned in the guide groove 76, it is possible to accomplish small movements of the comb (registration member) 410 in the horizontal direction.

Further, the registration jig 70 has a registration pin 74 for aligning the centers of the insertion holes 360 of the magnetic head 300 with those of the caulking holes 220 of the carriage 200, and the registration pin 74 is connected to a piston of a cylinder through an intermediate member; the pin is passed through the caulking holes 220 and the insertion holes 360 between a pair of guide members 75, thereby effecting alignment of the caulking holes 220 and the insertion holes 360.

Next, the magnetic head registration method of this embodiment will be described. First, the carriage 200 is placed at a predetermined position on the pallet device 400. Then, as shown in FIGS. 3 and 4, the comb (registration member) 410 of the registration jig 70 is positioned such that the forward end portions 411 thereof are placed between the adjacent carriage arms 210.

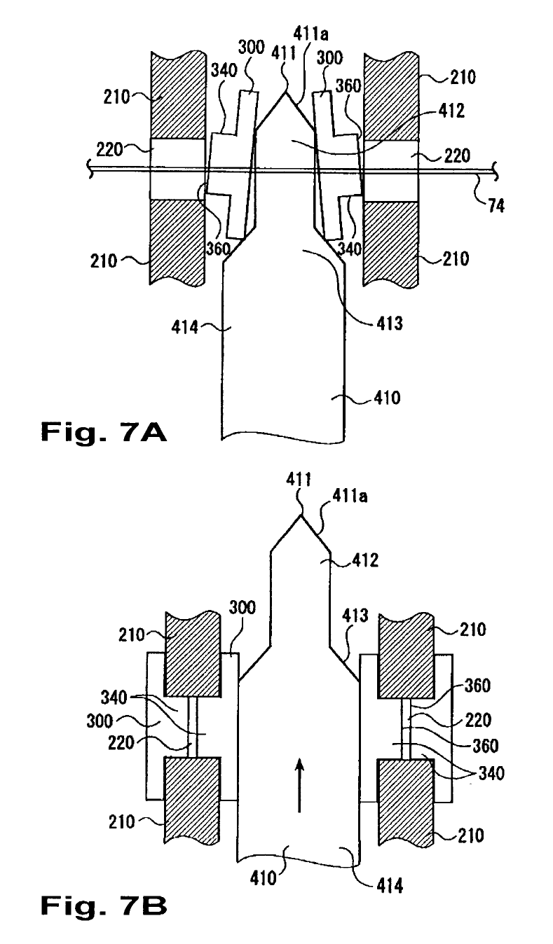

Next, the magnetic heads 300 are arranged between adjacent carriage arms 210. At this time, as shown in FIGS. 7A and 7B, the comb (registration member) 410 whose forward end portion 411 has been inserted is in a condition in which a gap S between a side wall of the second portion 414 and an inner wall of the carriage arm 210 is smaller than the thickness of the magnetic head 300. Thus, as shown in FIG. 7A, the magnetic heads 300 are placed on the second inclined portion 413, and the magnetic heads 300 can be supported between the carriage arms 210 and the flat portion 412. In this first stage, the magnetic heads 300 are just placed above the inclined portion 415 of the comb (registration member) 410, and the annular protrusions 340 have not been fitted into the caulking holes 220 of the carriage 200.

Next, the position at which the registration pin 74 can be passed through the caulking holes 220 of the carriage 200 and the insertion holes 360 of the magnetic heads 300 is ascertained by a sensor (not shown), and then the registration pin 74 is passed through the caulking holes 220 of the carriage arms 210, the insertion holes 360 of the magnetic heads 300, and an opening 419 of the comb (registration member) 410, whereby the centers of the caulking holes 220 of the carriage arms 210 and the insertion holes 360 of the magnetic heads 300 are arranged substantially coaxially.

Next, the comb (registration member) 410 is pushed up until the second portion 414 of the comb (registration member) 410 is positioned between the carriage arms 210. At this time, the magnetic heads 300 are obliquely pressurized (biased) by the inclined surface 415 of the comb (registration member) 410, whereby the annular protrusions 340 of the magnetic heads 300 are fitted into the caulking holes 220 of the carriage arms 210.

Subsequently, it is confirmed by the sensor that the annular protrusions 340 of the magnetic heads 300 have been inserted into the caulking holes 220, and then the registration pin 74 is pulled out.

Further, the comb (registration member) 410 is advanced between the carriage arms 210 from below the registration jig 70 until the adjustment portion 417 is positioned between the carriage arms 210, whereby a state is attained in which the magnetic heads 300 are biased against the carriage arms 210 with more force.

That is, the guide groove 76 in which the comb (registration member) 410 is placed is set to be substantially equal to the adjustment portion 417, so that when the registration pin 74 is inserted horizontally and when the second portion 414 is pushed upward, the comb (registration member) 410 is supported in a stable manner, whereby the annular protrusions 340 are reliably guided to the positions of the caulking holes 220 of the carriage 200.

Although the comb (registration member) 410 gradually advances upwards, the bent portion in the lower portion of the comb (registration member) 410 abuts the lower surface of the guide groove 76, so that the comb (registration member) 410 is not pushed in beyond a fixed amount.

By the above process, the annular protrusions 340 of the magnetic heads 300 are inserted into the caulking holes 220 of the carriage arms 210, and registration is effected such that the magnetic heads 300 can be fixed by caulking to the carriage arms 210.

Thereafter, the procedure advances to the next step, with the comb (registration member) 410 forced in; a steel ball is passed through and the annular protrusions 340 are caulked to the caulking holes 220 of the carriage 200.

In the pallet device 400 of this embodiment, due to the registration jig 70, the position where the caulking of the caulking holes 220 of the carriage arms 210 and the annular protrusions of the magnetic heads 300 are to be effected can be ascertained easily and reliably. Thus, by using the pallet device 400 equipped with the registration jig 70, registration is performed on the insertion holes 360 of the magnetic heads 300 with respect to the caulking holes 220 of the carriage arms 210 of the carriage 200, whereby it is possible to automatically perform a process to attain a state in which the magnetic heads 300 can be caulked to the carriage arms 210.

Further, by gradually pushing in the comb (registration member) 410, the annular protrusions 340 of the magnetic heads 300 are inserted into the caulking holes 220 of the carriage 200, so that the operation of the registration jig 70 is simple, thereby achieving an improvement in registration accuracy.

Further, since the registration pin 74 is passed through the caulking holes 220 of the carriage arms 210, the insertion holes 360 of the magnetic heads 300, and an opening 419 of the comb (registration member) 410, it is possible to prevent the magnetic heads 300 from being greatly deviated from the positions of the caulking holes 220 when the comb (registration member) 410 is pushed in, and the annular protrusions 340 are smoothly guided to the positions of the caulking holes 220. Thus, the magnetic heads 300 can be reliably arranged at a predetermined position of the carriage arms 210.

While in the registration jig 70 of this embodiment the comb (registration member) 410 advances upwards from below, this should not be construed restrictively. What is important is that the comb (registration member) 410 can advance between adjacent carriage arms 210.

In the magnetic head registration method of the present invention, registration is effected on the insertion holes of the magnetic heads with respect to the caulking holes of the carriage arms of the carriage, whereby it is possible to attain a state in which the magnetic heads can be fixed by caulking to the carriage arms. Further, the magnetic heads are placed between the registration member and the carriage arms such that the insertion holes of the magnetic heads are substantially opposed to the caulking holes of the carriage arms, and in a state in which the magnetic heads are placed between the carriage arm and the registration member, the centers of the caulking holes of the carriage arms and those of the insertion holes of the magnetic heads are arranged substantially coaxially, so that the magnetic heads are prevented from undergoing great positional deviation, making it possible to enhance the registration accuracy and operational efficiency. Next, the magnetic heads are biased toward the carriage arm side by the registration member, whereby the annular protrusions formed in the periphery of the insertion holes of the magnetic heads are fitted into the caulking holes of the carriage arms, and while maintaining the fit-in condition, the magnetic heads are biased with further force by the registration member, thereby bringing the insertion holes of the magnetic heads into close contact with the caulking holes of the carriage arms and attaining a state in which caulking fixation is possible.

Since the pallet device on which the carriage is mounted is equipped with a registration jig for performing registration on the magnetic heads, it is possible to lock the annular protrusions of two magnetic heads to the caulking holes of adjacent carriage arms, whereby it is possible to position the magnetic heads where the annular protrusions of the magnetic heads can be fixed by caulking to the caulking holes. Further, since registration can be effected on the magnetic heads while continuously maintaining the state in which the registration member is passed between the adjacent magnetic heads, the construction of the registration jig is simplified, and erroneous operation of the registration jig is prevented, thereby making it possible to achieve an improvement in registration accuracy. Further, in the third state, a predetermined clearance is provided between the registration member and the guide member, so that the registration member can accomplish small movements in the biasing direction, and the annular protrusions of two magnetic heads placed between adjacent carriage arms can be locked to the caulking holes of the carriage arms, whereby the magnetic heads can be positioned where the annular protrusions of the magnetic heads can be fixed by caulking to the caulking holes. Further, since registration can be effected on the magnetic heads while continuously maintaining the state in which the registration jig is passed between the magnetic heads, the construction of the registration jig is simplified, and erroneous operation of the registration jig is prevented, whereby an improvement can be achieved in terms of efficiency in registration operation. Further, in the third state, a predetermined clearance is provided between the registration member and the guide member, so that the registration member can accomplish small movements in the biasing direction, and if, after the magnetic heads have been placed, the caulking holes of the carriage arms and the annular protrusions of the magnetic heads are deviated from each other, the registration member makes small movements, making it possible to adjust the positions of the magnetic heads.

Thus, by using the pallet device equipped with the registration jig, the magnetic heads can be inserted between the carriage arms, making it possible to automate the magnetic head assembling operation.

Thus, it is possible to realize automation of assembly operations and achieve an improvement in operational efficiency and registration accuracy to thereby achieve an improvement in terms of yield.

What is claimed is:

1. A magnetic head registration method in which registration is performed on insertion holes of magnetic heads with respect to caulking holes of carriage arms of a carriage, whereby it is possible to attain a state in which the magnetic heads can be fixed by caulking to the carriage arms, the registration method comprising:
setting a registration member such that magnetic heads can be placed between the registration member and carriage arms;
placing the magnetic heads between the carriage arms and the registration member such that insertion holes of the magnetic heads are substantially opposed to caulking holes of the carriage arms;
arranging the centers of the caulking holes of the carriage arms and the insertion holes of the magnetic heads substantially coaxially;
biasing the magnetic heads toward the carriage arm side by the registration member to thereby fit annular protrusions formed in the periphery of the insertion holes of the magnetic heads into the caulking holes of the carriage arms; and
biasing the magnetic heads with further force by the registration member while maintaining the fit-in state to thereby bring the insertion holes of the magnetic heads into close contact with the caulking holes of the carriage arms to attain a state in which caulking fixation is possible.

2. A pallet device which is conveyed in each step while holding a carriage when mounting magnetic heads to the carriage, the pallet device comprising a registration member for registration insertion holes of the magnetic heads with respect to caulking holes of a plurality of carriage arms provided in the carriage,
wherein the registration member is equipped with:
a first portion for attaining a first state in which the magnetic heads can be respectively placed between the carriage arms in a condition in which the registration member is positioned between the carriage arms;
a second portion which has a diameter larger than that of the first portion and which, after the state has been attained in which the magnetic heads are respectively placed between the first portion and the carriage arms, is pushed in between the carriage arms to bias the magnetic heads toward the carriage arm side to thereby achieve a second state in which annular protrusions formed in the periphery of the insertion holes of the respective magnetic heads are fitted into the caulking holes of the carriage arms;
a third portion which has a diameter larger than that of the second portion and which, after the state has been achieved in which the annular protrusions of the respective magnetic heads are fitted into the caulking holes of the carriage arms, is pushed in between the carriage arms to bias the magnetic heads with further force toward the carriage arm side to thereby bring the insertion holes of the magnetic heads into close contact with the caulking holes of the carriage arms to realize a third state in which caulking fixation is possible; and
a fourth portion which exists between the second portion and the third portion and which serves to maintain the state in which the magnetic heads are biased toward the carriage arm side also during transition from the second state to the third state.

3. A pallet device according to claim 2, further comprising a guide member which guides the registration member such that it can operate in a predetermined direction during the transition from the first state to the third state, whereby it is possible to smoothly guide the operation of the registration member,
wherein in the third state, a predetermined clearance is provided between the registration member and the guide member so that the registration member can make small movements in the biasing direction.

4. A registration jig which performs registration on insertion holes of magnetic heads with respect to caulking holes of carriage arms of a carriage to thereby attain a state in which the magnetic heads can be fixed by caulking to the carriage arms, the registration jig comprising a registration member and a guide member for guiding the registration member,
wherein the registration member is equipped with:
a first portion for attaining a first state in which the magnetic heads can be respectively placed between the carriage arms in a condition in which it is positioned between the carriage arms,
a second portion which has a diameter larger than that of the first portion and which, after the state has been attained in which the magnetic heads are respectively placed between the first portion and the carriage arms, is pushed in between the carriage arms to bias the magnetic heads toward the carriage arm side to thereby achieve a second state in which annular protrusions formed in the periphery of the insertion holes of the respective magnetic heads are fitted into the caulking holes of the carriage arms;
a third portion which has a diameter larger than that of the second portion and which, after the state has been achieved in which the annular protrusions of the magnetic heads are fitted into the caulking holes of the carriage arms, is pushed in between the carriage arms to bias the magnetic heads with further force toward the carriage arm side to thereby bring the insertion holes of the magnetic heads into close contact with the caulking holes of the carriage arms to realize a third state in which caulking fixation is possible; and
a fourth portion which exists between the second portion and the third portion and which serves to maintain the state in which the magnetic heads are biased toward the carriage arm side also during transition from the second state to the third state, and
wherein the guide member guides the registration member such that it can operate in a predetermined direction during transition from the first state to the third state.
